(19) United States
(12) Patent Application Publication
(10) Pub. No.: US 2013/0275512 A1
(43) Pub. Date: Oct. 17, 2013

(54) LIFE EXPERIENCES CERTIFICATION PROCESS

(71) Applicants: Donald H. Skelton, Bonita Springs, FL (US); Patrick O'Meara, Naples, FL (US)

(72) Inventors: Donald H. Skelton, Bonita Springs, FL (US); Patrick O'Meara, Naples, FL (US)

(21) Appl. No.: 13/919,340

(22) Filed: Jun. 17, 2013

Related U.S. Application Data
(63) Continuation of application No. 13/198,548, filed on Aug. 4, 2011.
Application No. 13/198,548 is a continuation-in-part of application No. 12/610,721, filed on Nov. 2, 2009, now abandoned.

(51) Int. Cl. H04L 29/08

(52) U.S. Cl. CPC H04L 67/306
USPC 709/204

(57) ABSTRACT

A process of information certification is provided. The process includes receiving a request from a user, such as an individual, group, or entity, and dividing the categories into two parts. Checking and certification is performed by a Host where possible on existing categories of subject matter. Additional categories are generated for new information to be checked and certified. Certifications are provided for all categories which can be and have been checked. The certification process is continued in the future—either automatically and/or upon request—to include any new information provided by the user or found in regular searches.

### CROSS-REFERENCE TO RELATED APPLICATIONS

This is a Continuation application of U.S. patent application Ser. No. 13/198,548, file on Aug. 4, 2011, which is a Continuation-In-Part of U.S. patent application Ser. No. 12/610,721, filed on Nov. 2, 2009, and also claims priority from U.S. Provisional Application No. 61/499,061 filed Jun. 20, 2011.

### TECHNICAL FIELD

The present invention relates generally to certifications for users' experiences, achievements, educational pursuits, personal interests and the like in comprehensive social biographical profiles. The invention can service individuals, groups, entities, employers and job applicants, to allow them to accurately portray background, life experiences, social views and interactions and life objectives,

### BACKGROUND OF THE INVENTION

Technology today has allowed dissemination of a tremendous amount of information and data relative to people, places, businesses, etc. There are numerous websites and other media from which information and data can be obtained. Some of the data comes from sites or sources that are reputable and accurate. The source and accuracy of other data is often suspect and often untrue.

The data could be published or disseminated by the user, or it could be provided by others, known or unknown. The data and information, particularly for individuals, also could change over time as the person advances into other endeavors or reacts to other challenges. It would be preferable if the data were checked for accuracy or accredited by reliable sources so that the truth and accuracy of the data and information would be assured.

The desirability and need for thorough and accurate information relative to individuals and others does not end with employment interviews. It can extend to the intricacy of the person's live and can include virtually everything that the person experiences, desires, or gains knowledge of throughout the person's existence. Facts or data about persons' lives can grow as the persons grow and is useful for many applications, including continued or new employment, entry into other endeavors, attractiveness to others with similar interests, and the like.

It would be useful for the persons themselves, as well as others with an interest in such persons, to have a credible and certifiable source for ascertaining ongoing information relating to them. It is an object of this invention to provide systems and processes for accomplishing this.

Individuals, as well as businesses, social groups, political groups, etc. all have a need to have their history, objectives, activities, experiences, and accomplishments updated and portrayed accurately.

The desirability and need for accurate and truthful data relative to persons is evident in many areas and in many disciplines, particularly in employment situations. The desirability and need also is evident throughout the lives of the persons, groups and entities, also for many reasons.

In the employment area, in particular, the advancement of industry technology has generated an ever increasing need within corporations for employees with highly specific skills and backgrounds. This, in turn, has resulted in complex and costly process of interviewing and reviewing job applicants. Commonly, a corporation must review a large number of resumes to isolate candidates with the right background for a particular position. The resulting candidates are then interviewed and examined to find the most suitable matches. Due to possible errors and misleading statements on resumes, the resumes are often submitted to an investigation to verify pertinent facts and statements contained on them. These investigation can be extremely expensive. In addition, these investigations are often performed after considerable time and cost have already been expended by the corporation in narrowing the number of patented candidates and selecting the few best potential candidates for the job position. As a result, these processes are extremely inefficient and non-cost effective for both potential employee as well as employer.

It is known that a significant percentage of resumes, networking sites and internet social sites may contain information that is factually inaccurate or incorrect. While often the mistakes are insignificant, it is important that profiles of groups and individuals be stated accurately and that potential employers have confidence in the accuracy of resumes and social profiles. For example, human resource officers (HRO) can spend an enormous amount of time sifting through resumes to select candidates for positions within their company. After the applicant gets through the interview and is selected, the HRO then conducts a background check before the candidate becomes employed by the company. A large number of man hours are typically invested in a potential candidate before the background process even begins.

A corporation could engage a certification company to review all submitted resumes prior to the interview process. This, however, is known to be extremely costly as well. In this scenario, each of the resumes submitted for a position would incur a certification cost. Thus the employer would be paying to verify a large number of resumes whose candidates may likely be dismissed in early reviews. In addition, received resumes often comprise a wide variety of information having differing certification difficulties. Therefore, certification of batches of resumes cannot be accomplished in a uniform manner. The cost to most corporations, outside of secure government positions, renders this methodology impractical.

Finally, the information on a candidates resume that is vital may significantly vary depending on the particular employer or even the particular position to be filled. A particular employer or position may require applicant details that are unique or uncommon from a standard resume. While some employers may require extensive verification of every detail, certain employers may have simpler requirements such as a criminal background check and a high school diploma. It would be highly efficient to utilize a flexible system that did not incur verification costs except when necessary.

It is therefore one of the objects of the present invention to provide a resume certification process that would pre-certify an individual's resume so as to provide to employers a candidate's resume that can be relied on as being accurate. The process provides a unique and efficient service that pre-certifies resumes to weed out resumes that are either embellished or fraudulent. The process will be accomplished in a large part through an electronic process that will be much more efficient than a HRO sifting through resumes and interviewing candidates who may have resumes containing inaccurate or misleading information. It is a further intention of the present invention to provide an online database of resumes that are pre-certified as correct so as to pair employee needs to prospective applicants who are qualified to address these needs. This provides a significant advantage to both candidate as well as employer.

It is a still further object of the present invention to provide a certification process which can be used by individuals and others to update and accurately portray biographical and social profiles, particularly for networking and ongoing interests. This process also provides a unique, efficient and cost effective service that can certify histories, activities, experiences, additional education, accomplishments, changes, and objectives.

### SUMMARY OF THE INVENTION

In accordance with the objects of the present invention, processes of social networking certifications and resume certifications are provided. As to the resume certification, the process includes receiving a resume from an individual and submitting the resume to a baseline certification process to produce a baseline certified resume. The process further includes storing the certified resume in a candidate database. The process includes charging the individual for the certification and storage within the candidate database. The process further includes accepting potential candidate requirements from prospective employers and identifying resumes belonging to relevant candidates from the candidate database. Finally, the process provides the prospective employers with the resumes of such relevant candidates in combination with the certification.

The resume certification process further provides generating employer defined additional certification categories. The process identifies potential positions or employees requiring the additional certification categories. Finally the process allows individuals to pay for additional certification of the additional certification categories to have their resumes moved from the baseline candidate database to a tailored candidate database. The process further includes accepting potential candidate requirements from prospective employers and identifying resumes belonging to relevant candidates from the tailored candidate database. Finally, the resume certification process provides the prospective employers with the resumes of such relevant candidates in combination with the additional and baseline certification.

In accordance with another embodiment of the invention, the system can combine varied intelligence in automatic documentation as a result of certifiable additional education, activities, awards, publications and the like, which are secured, learned or achieved cumulatively over the users' lives. Based on information and data provided by the user, a base is developed of the user's knowledge, patterns and correlations. The users' profiles are continually updated and changed—often automatically—to include the user's life experiences and then current situations.

With this embodiment of the present invention, the users' profiles can be authenticated through certification. The user's education, achievements, interests and life experiences can be researched, checked and certified, which allows others, such as social contacts, networking objectives, current or prospective employers, and the like to quickly and accurately gain all of the important and significant facts of the users.

The users also can use the profiles to connect with others, such as professionals, with similar knowledge, education and life experiences. The user can also be kept up to date with the achievements, professional or others, such as friends and colleagues. This could lead to increased communication with other persons, groups, and organizations, whether social, business, education, political or otherwise.

The invention can encourage the users to invest into further training and education, which can improve the lives and situations of users themselves, as well as their employers and acquaintances.

Objectives stated by the users also can be published and acted upon. The invention can provide information to advise users on what training, education, experience, etc. is needed to reach desired goals.

The data entered and submitted into the database can also be selectively disseminated to others.

Other objects and features of the present invention will become apparent when viewed in light of the detailed description and preferred embodiments when taken in conjunction with the attached drawings and claims.

### BRIEF DESCRIPTION OF THE DRAWINGS

FIG. 1 is an illustration of an embodiment of a process of resume certification in accordance with the present invention.

FIG. 2 is a detail illustrating types of resumes that can be certified.

FIG. 3 is a detail illustrating a certification process directed towards education for use in the process illustrated in FIG. 1.

FIG. 4 is a detail illustrating a certification process directed towards professional experience for use in the process illustrated in FIG. 1.

FIG. 5 is a detail illustrating a baseline certification process directed towards professional certification for use in the process illustrated in FIG. 1.

FIG. 6 is a detail of the process in FIG. 1 illustrating additional steps.

FIG. 7 is an alternate embodiment of the detail illustrated in FIG. 6.

FIG. 8 is an alternate embodiment of the detail illustrated in FIG. 6.

FIG. 9 is an alternate embodiment of the detail illustrated in FIG. 6.

FIG. 10 is an illustration of an embodiment of a process for creating a social networking profile.

### DESCRIPTION OF PREFERRED EMBODIMENTS

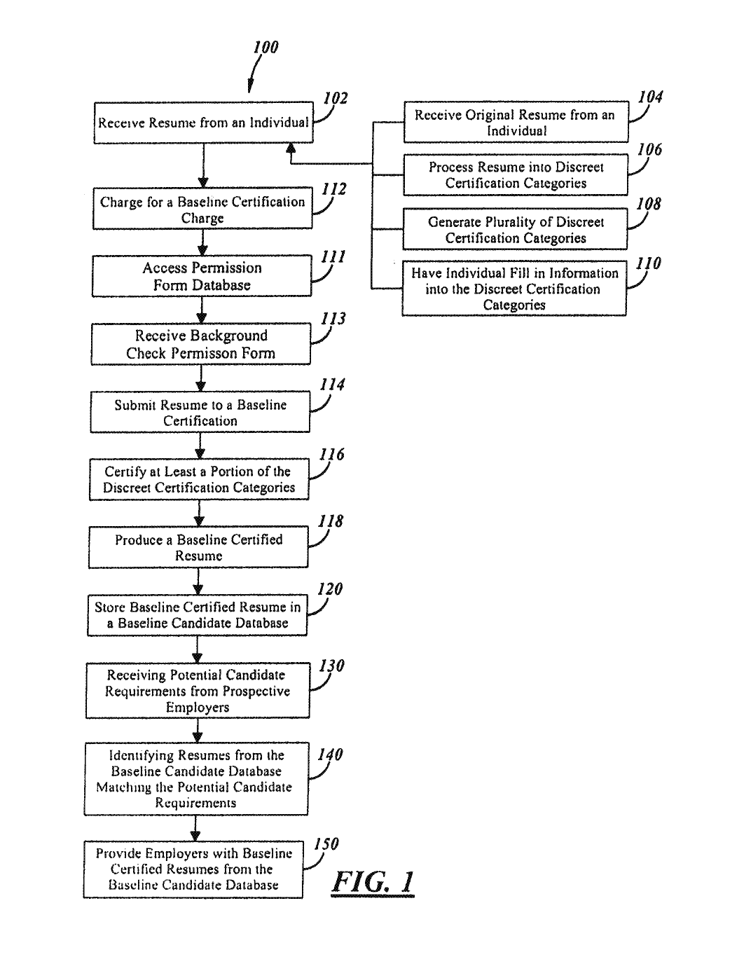

Referring now to FIG. 1, which is an embodiment of a resume certification process 100 in accordance with the present invention. The process 100 is comprised of receiving a resume from an individual 102. It is contemplated that this may be comprised of receiving a complete resume from an individual 104 and processing said resume into discreet certification categories 106. In addition, it is contemplated that this may be comprised of generating a plurality of discreet certification categories 108 and having an individual fill in said discreet certification categories 110. The second methodology is efficiently adaptable to online submission of resumes by individuals.

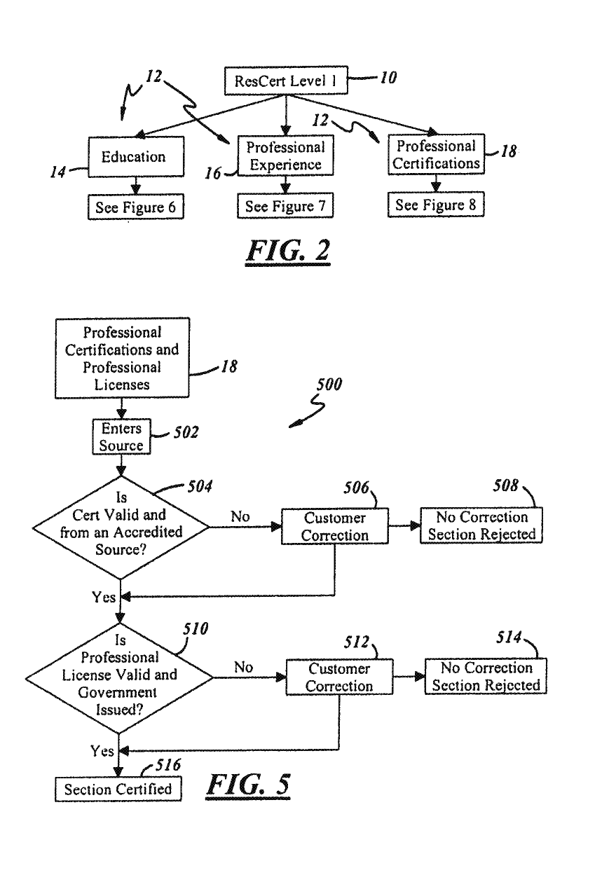

In the basic operation of the aforementioned process a candidate will order the services via a webpage designed for the present unique process. The candidate will submit a resume 10 (FIG. 2) by filling-in the necessary fields or certification categories 12 provided by the software. It should be understood that it is contemplated that all discreet certification categories need not be actually certified during the claimed process. The items being certified can be selected or designated by the candidate and/or the employer. Furthermore, it is contemplated that the discreet certification categories 12 may encompass a wide variety of resume categories such as name, address, educational history, job history, professional certifications, licenses, skills, criminal history, security clearances and a variety of other categories to name just a few. The process specific to a few sample discreet categories 12 such as education 14, professional experience 16, and professional certifications 18 is disclosed in more detail, although the substance of these processes may be applicable to any of the potential discreet categories 12.

Once the individual's resume 10 has been received, the process charges the individual, or a company, with a baseline certification charge 112 and submits the resume 10 to a baseline certification process 114 (FIG. 1). This is preferably accomplished through the use of a credit card or debit card online. It should be understood that the baseline certification 114 is intended to encompass a wide variety of official verifications including, but not limited to, polling known or generated databases, phone inquiries, credit checks, government records and other investigative measures. The baseline certification is intended to officially certify at least a portion, if not at all, of the discreet certification categories 116. It is intended that the baseline certification covers the standard basics required by most companies such as educational and employment history. By generating a baseline certification 114, the present process provides a cost effective certification that satisfies the vast majority of employers and applicants. In at least one embodiment, the baseline certification can certify all of the categories 12 presented to the applicant by the website.

It is further contemplated that the present invention requires the submission of a background check permission form 113 prior to beginning any certification proceedings 114. This includes, but is not limited to, permission to check education and employment history. The present invention contemplates developing and accessing a permission form database 111 such that the required language or verbiage of a particular institution may be included if necessary. The present invention automatically matches the entered school or corporation with required verbiage and incorporates it into the background check permission form 113. This insures a quick and reliable confirmation process that allows individual institutions to retain a level of privacy release that they are already accustomed to. In addition, as individual institutional requirements are discovered and added to the database, they will automatically be applied to the permission form of future candidates associated with the same institution.

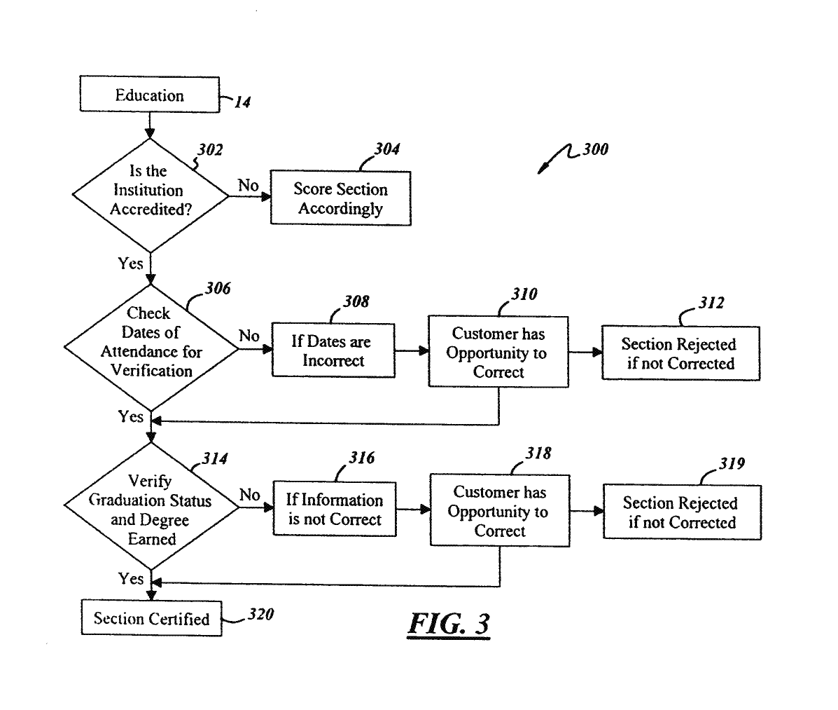

Although the present invention contemplates a variety of certification methodologies that may vary depending on the discreet certification categories 12 a few specific processes are provided in more detail. FIG. 3 is an illustration of an embodiment 300 of the certification methodology as it applies to education 300. The first educational certification step will be to determine if the educational institution is in fact a legitimate institution accredited by the US Department of Education 302. If the educational institution is accredited or non-accredited it will be scored accordingly 304. Scoring is utilized such that non-accredited institutions or non-verified institutions may still be certified but will be noted as such. In one embodiment, it is contemplated that the scoring comprises reducing a percentage of reliability to a percentage such as 80% to indicate that the school in non-accredited. In other embodiment, a notation of non-accreditation will be applied. The verification of accreditation of high schools will be preferably accomplished through the use of an in house database of listed institutions. Verification of post secondary education will be electronically checked with the U.S. Department of Education. In instances where the candidate has not earned a degree from a traditional secondary institution but has received a GED, the process electronically checks with the appropriate state agency to verify the information.

The electronic verification of accreditation is followed by a certification of attendance verification 306 to verify the dates of attendance. This is preferably accomplished electronically through a student clearinghouse database where possible. An in-house electronic system is utilized to contact institutions not on record with the student clearinghouse to certify attendance at the respective institutions. In at least one embodiment, this constitutes electronically contacting the institution with the request in combination with the permission form. The certification checks the dates of attendance 308 for error and if found notifies the candidate electronically that there are inaccuracies in the aforementioned section and provides an opportunity to correct and resubmit the section for certification 310. If the information is not corrected, the section is rejected 312 and the resume or section will not receive certification. In at least one model of the present invention, the candidate is charged a surcharge to correct the certification. In another model, if the inaccuracies are weighted and if found sufficiently minor, the system will prompt the candidate with the correct information. Thus, if it is clear that attendance is only a month off or if an error is clearly typographical, the candidate is allowed to correct without surcharge.

After verification of attendance 306 is finished, the graduation and degree earned information listed on the resume are verified for accuracy 314. Where internal or external databases are electronically available, they are utilized. Where institutions only release data with permission, the institution is contacted electronically with the appropriate permission form. If the graduation status and/or degree are not correct 316, the candidate is notified electronically of the inaccuracies and given the opportunity to make corrections and resubmit the section for verification 318. If the information is not corrected, the section is rejected 318 and the section/resume will not obtain certification 319. If all the information in the educational certification 300 is accurate, the educational section will be certified as accurate 320.

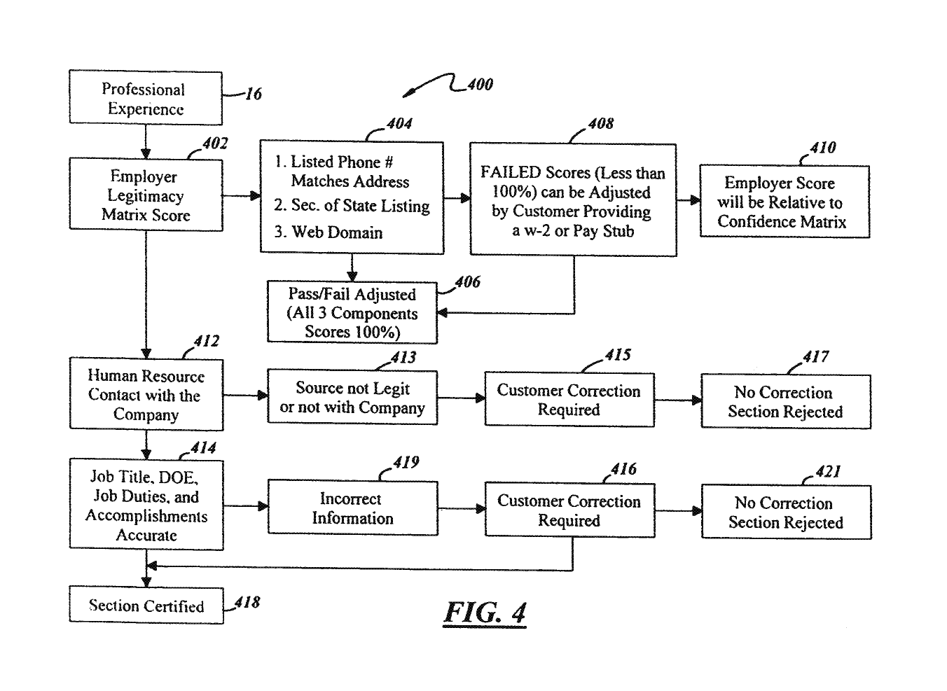

In addition to the certification of education 300, the present invention contemplates a process for the certification of employment history 400 as shown in FIG. 4. The process includes utilizing a unique Employer Legitimacy Manic (ELM) 402 to help prevent the possibility of fabricated work history or the attempt to cover up potential gaps in employment. The contemplated unique matrix preferably has a unique three-point checklist to determine if the company listed is legitimate 404. The checklist includes checking if the company has a phone number matching the address listed, a Secretary of State listing, or a web domain. In one embodiment, the company is given a pass/fail score if any of the three checkpoints are satisfied 406. It is contemplated, however, that a company that fails all three checkpoints may be adjusted by the candidate to a passing status by submission of a W-2 or paystub from the company 408 to ensure its legitimacy. In another embodiment, if the company satisfies all three checkpoints, the company is assigned a score of 100% 406. If the company scores less than all three checkpoints, the score is reduced accordingly. In this embodiment, it is contemplated, however, that scores less than 100% may be adjusted by the candidate to 100% by submission of a W-2 or paystub, from the company 408 to ensure its legitimacy. In this embodiment, where the company is a small operation or is not in operation and the candidate fails to provide a W-2 or paystub, an employer score will be attached to the employment selection reflecting the reliability 410.

Once the company is checked through the ELM 402, the process electronically contacts the human resource office of the employer 412. The process confirms the legitimate identity of the human resource office by verifying legitimate company email address, fax number, or telephone number 413. The process further confirms that only current employees of the listed company responsible for handling HRO duties will be acceptable to complete certification of this section. This prevents the use of prior co-workers to act as fronts for the human resource department. The process utilizes internal and external databases to verify proper HRO contact. If the HRO information is not verified the candidate is afforded an opportunity to correct the data and resubmit for certification 415. If the data is not confirmed, then the section/resume is not certified 417.

Where a company is no longer available, the company will be scored using the employer legitimacy matrix 402 to determine if the company was operating during the time period that candidate listed. The human resource office contact 412 will then be an officer of the corporation filed with the respective secretary of state records. In this case, the web domain may be removed from the matrix of verification. The requirement of checking with a legitimate human resource officer 412 prevents the fabrication of contacts at past employers who are now defunct.

In either case, the human resource office contact will electronically verify that the candidate has correctly listed dates of employment, job duties, job salary, and accomplishments accurately 414. It should be understood that the aforementioned list for verification may be modified as would be understood by one skilled in the art in light of this specification. If any of the elements are not correct 419, the candidate will be electronically notified and will have an opportunity to make corrections and resubmit for certification 416. If the information is not corrected, the section is rejected and the section/resume will not receive certification 421. If, however, the information can be verified, the employment section is certified 418.

It is contemplated that some candidates may have military experience listed within the employment section that require a unique method of verification. The military commonly protects such records closely and makes outside receipt difficult. Therefore, the present invention contemplates a two step process of requiring the candidate to supply a copy of their discharge papers to verify dates of service, military branch and rank, and discharge status 420. In addition, the candidate must sign a form acknowledging the penalties for falsifying military records.

In a certification method similar to the ones above, the present invention contemplates a unique method of verifying professional certifications 500 (FIG. 5). The candidate electronically enters the professional certification or license in addition to the source where the certification or license was obtained 502. The process then determines if the professional certification/license is from an accredited source 504. It is contemplated that the determination of an accredited source 504 may be electronically verified using a clearinghouse database or internal records. If the verification cannot be obtained with the clearinghouse or internal database, the customer supplied accreditation source is contacted for verification. If the accreditation cannot be verified, the candidate may correct the information and resubmit for certification 506. If the information is not corrected, the section/resume is rejected 508 and not certified.

If the professional license is obtained through state agencies it will be verified electronically through the respective state agency that granted the license 510. The status of the professional license and dates obtained will be verified. If any elements are not accurate, the candidate will be electronically contacted 512 to correct the data and resubmit for certification. If corrected data is not obtained, the section/resume is not certified 514. If the new data is confirmed, the section is certified 516.

It is further contemplated that the present invention may include a section for personal accomplishments including membership in organizations. It is contemplated that similar to the above, the candidate will be asked to submit valid contact information for the organization that can be verified as legitimate through a web based source or listed phone number in an identical fashion to the above.

If all sections are verified, the resume may be certified as accurate in its entirety. The present invention also contemplates that resumes often include special skills or other details of the applicant that are not readily verifiable through an accredited source. These may include skills such as typing and foreign language mastery for example. The present invention contemplates allowing the candidate to include the certifiable and non-certifiable information into an assortment of resume templates such that a resume with a professional appearance is generated. It is contemplated that the non-certifiable sections will be reflected as such on the final resume. In addition, the present invention contemplates that full certification of all sections may not always be desirable and therefore contemplates utilizing the aforementioned verifications in the following process.

The present invention utilizes the baseline certified resume 118 (FIG. 1). It is contemplated that the baseline certified resume may be comprised of a resume containing only verified information. It the second case, it is contemplated that the baseline certified resume 118 clearly identifies the verified information (such as by symbol, highlighting, etc.) as separate from the non-certified categories. The present invention then contemplates storing the baseline certified resume in a baseline candidate database 120.

In one embodiment, it is contemplated that the resumes stored in the baseline candidate database may simply be sent to potential employers at the behest of applicants as an official resume. This relieves the employer of the necessary background checks and instills confidence in the information presented. In another embodiment, however, it is contemplated that the process accepts potential candidate requirements for prospective employers 130. The process then identifies baseline certified resumes from the baseline candidate database having verified information matching the potential candidate requirements 140. The process then provides the prospective employers with the identified baseline certified resumes 150. This allows the prospective employers to be provided with a list of candidates that not only meet their requirements, but have had those requirements pre-verified as accurate. This both increases the value of the candidates resume as well as significantly reduces employer time and cost.

The present invention contemplates that resumes and employment requirements vary quite significantly, beyond the baseline basics, depending on career, profession, employer and even specific positions within the employer. It is therefore contemplated that a range of detailed certification is desirable for both efficiency and cost. A janitorial position, for example, may only truly require high school diploma verification as well as place of last employment. A defense contractor position, however, may require verification of criminal history, post graduate education, accurate job history, and an accurate list of prior residences to facilitate the issuance of a security clearance. Furthermore, specific employers or positions may require details not found on common resumes, such as bar admission or computer software certification.

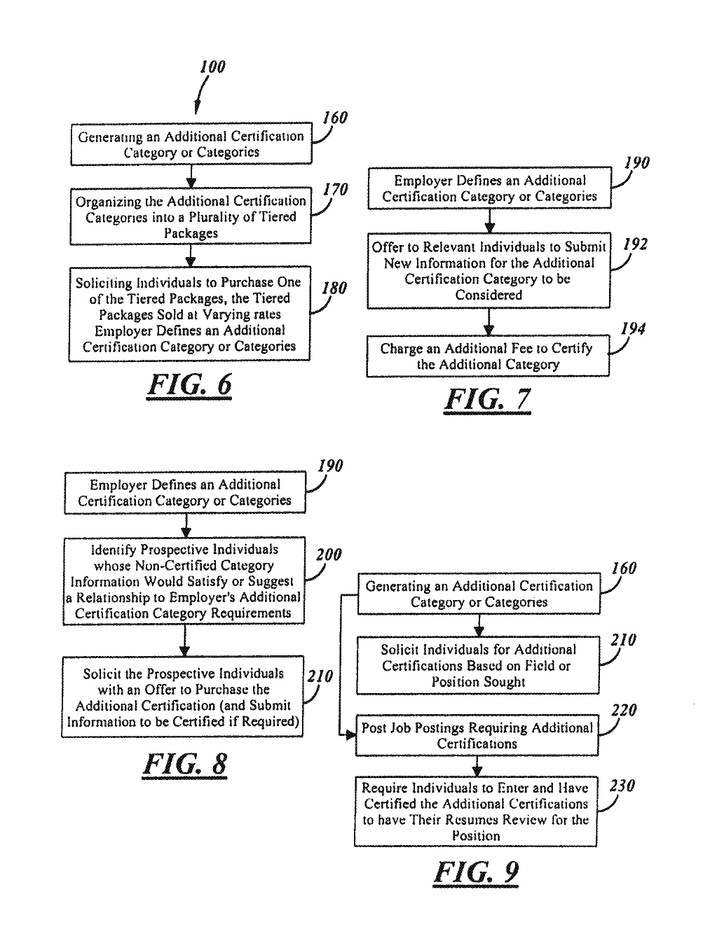

For these reasons, the present invention contemplates the generation of at least one additional certification category 160 or categories (See FIG. 6). These additional certification categories may comprise employer defined additional certification categories, field of employment designed additional certification categories, or position defined additional certification categories as discussed above. One embodiment contemplates organizing the additional certification categories into a plurality of tiered packages 170. The tiered packages are then sold to individuals at differing rates 180. In this fashion, a person new to the job force may not be required to pay as much as a twenty-year physician's assistant. Similarly, employers will be inherently dealing with a more tailored group of applicants as the complexity of background increases. Although these additional certification categories may be pre-determined and offered on a tiered basis to individuals submitting resumes, there also may be unique categories that are too specific to be dealt with in any common applicant basis. Familiarity with a particular brand of machining tool may be vital for one employer or position, but would not warrant inclusion in the central processing.

The present invention, therefore, contemplates that an employer may define an additional certification category 190 (FIG. 7). The process then offers to relevant individuals to submit new information for the additional certification category to be considered (192). The individual is then charged an additional fee to certify the additional certification category (194). The identification of such individuals may be accomplished utilizing existing certified and non-certified categories that complement the additional certification category (such as general machining background for example). Alternatively, the process may simply identify prospective individuals whose non-certified category information would satisfy the employers additional certification category requirements 200. This is shown in FIG. 8. This may be accomplished by allowing individual generated categories or information during the entry process and searching these non-certified categories by keyword.

In either case, the present invention then contemplates approaching these prospective individuals with an offer to purchase the additional certification. 210 (FIG. 8). This may be accomplished in many ways a variety of fashions. In one embodiment, an individual would simply be solicited for additional certifications directed towards a particular field or position they seek. In another embodiment, job postings 220 could be posted and individuals would be required to enter and or have certified the additional certifications 230 in order to have their resumes reviewed for the position (FIG. 9). In this fashion, employers may require and receive verification of highly specific details thus far unknown in most resumes. The ability to not only identify these unique individuals from a mass database, but to economically have verification of their unique abilities, provides an advantage to both highly specialized employers and highly skilled employees alike.

Another feature of the present invention is contemplated to be a human resources organization clearinghouse database generated by the certified resumes submitted by candidates. The clearinghouse will enable employers to view the data on a secured website to ensure them that the resume has not been tampered with after certification. In one embodiment the potential employer will be given a resume number exclusive to the candidate's certified resume that will allow them access to the website. In another embodiment, the candidate will be given a personalized link that they can include on the resume they submit to an employer. By accessing the link on the web, the employer can again access to the certified resume online to avoid tampering. This may also be accomplished by allowing the candidate to email the certified resume directly through the secured website hosted by the certification company. The email will give the potential employer access to the secured website to view the certified resume. Finally, it is contemplated that the candidate be given an encrypted image that, when submitted to the secured website, pulls up the certified resume. The encrypted image is preferably black and white in nature such that it can be contained on a printed resume, scanned in, and then utilized to access the secure website online.

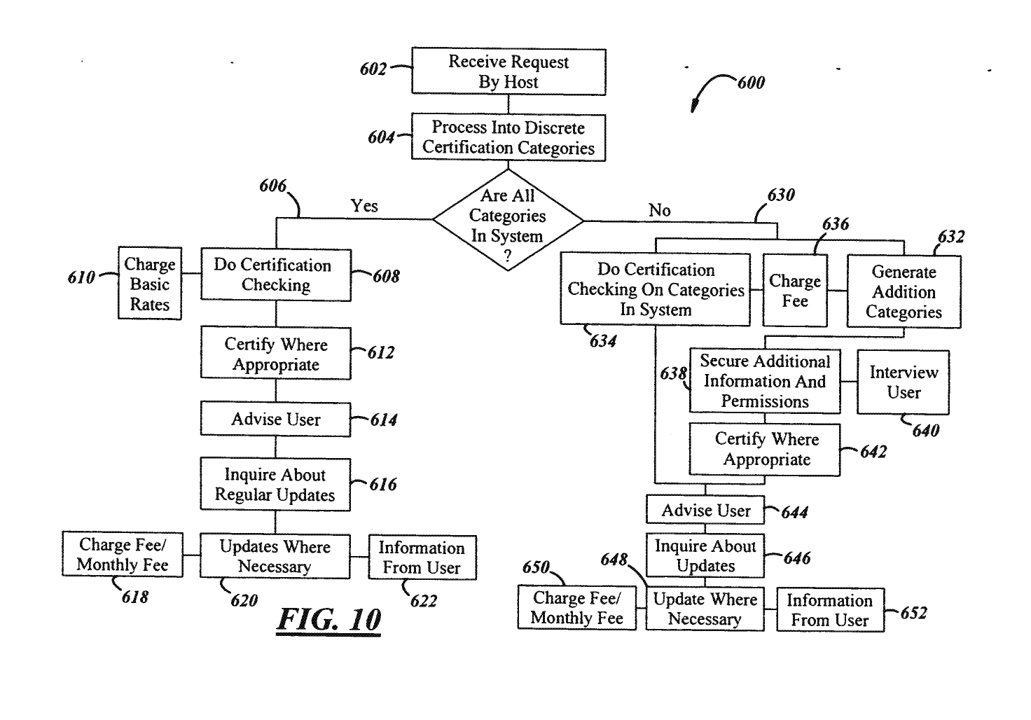

A second embodiment of the invention is described below and shown in part in FIGS. 10 Referring now to FIG. 10, the process 600 starts with receipt by the “Host” of a request 602 from the person, group, entity or the like For convenience, the requestor will be referred to herein as a “person” or “user”, but it is understood that the system is not limited to use by individuals. This embodiment of the invention can be used by an individual, teams, groups, businesses, entities and the like. Also, the term “Host” is used to refer to the group, business or entity that is providing the information and profile certification service for the person or user of the services.

FIG. 10 schematically sets out a basic generic process 600 for creating and updating a social networking profile. As shown in FIG. 10, the process begins with the user requesting a profile program by sending a request to the Host. The Host receives the request at 602. The Host reviews the request and upon receiving input from the user, determines which of the categories the Host already has in its system. The request thus is divided into discrete certification categories 604.

If all the categories desired to be checked and certified are already in the Host's system 606, then certification research and checking is initiated 608 and the user is charged a fee 610. The information in the categories are then certified where possible 612 and the user is advised 614.

At about the same time, the user is asked 616 if he/she wants to have the ability to enter data and information subsequently into the profile for the Host to regularly update the profile and certify any new data where appropriate. An inquiry is also made as to whether the user wants the Host to automatically update the user's profile. If the user agrees, then a fee is charged 618 or a monthly fee arrangement is established. Then the profile is updated where appropriate in the future 620 and the new information and data is checked and certified where appropriate. The user is contacted 622 to provide information and permission documents where appropriate.

If all of the categories are not currently in the Host's system 630, then new categories are generated 632. Checking and certification of the established categories 634 is also performed. The user is charged a fee 636 for this service by the Host. Any necessary information and permissions are secured from the user 638, including from an interview with the user 640 if necessary. Thereafter, the information and data is certified 642 where appropriate and the user is advised 644 of the results.

The user is also asked if he/she wants to regularly update the profile and have the Host do additional certifications in the future 646. If so, the certification and data updating are performed 648 and the user is charged a one-time or monthly fee 650. The user may also be asked to provide additional information 652, or the user may supply additional information voluntarily.

For convenience, the matter requested by the user or person will be referred to herein as a “social networking profile”, but it also could be referred to as an expanded resume, or biography. The user can set up its own searchable site, but preferably, the social networking profile is set up and only available from the Host who established the network profile services.

In general, the establishing company sets up an internet site that can be accessed by the user (through a password) and designated who are allowed to view the profile. Access to the profiles can be restricted in many ways, to specified individuals, to certain groups, to certain businesses, and the like. All of the access would be read-only access, with only the establishing. Host company having the right and ability to make changes or additions to the items on the profile. Regular fees are charged to the users in order to update categories on a regular basis, or to amend or supplement with additional data supplied by the user. If the user asks for new categories to be added and/or certified, additional fees can be charged.

The categories that can be asked to be certified include, for example: (1) charitable activities, including years of service, titles and duties; (2) membership in certain clubs, groups, organizations, including years of membership, titles, or offices held, and duties; (3) membership in “good standing” in certain groups; (4) hobbies; (5) reading materials that the person has read, may read or recommends to others; (6) languages known, including ability to read and speak in certain languages; (7) personal interests; (8) outside activities; (9) places visited; (10) personal philosophies and/or religion; (11) screen name or other identifier names; (12) email address; (13) reachability through twitter or websites; (14) links to websites; (15) internet social groups; (16) passport; (17) updated photographs of the person or other individuals; (18) personal specialties and skills; (19) directorships or officers of groups or entities; (20) interest in other social or business clubs; (21) changes/advancements in business; (22) awards; (23) publications/articles authored or co-authored; (24) high school, including activities and sports teams; (25) active interests, such as jogging, golf, tennis, etc.; (26) financial matters; (27) mentors, coaches or advisors; (28) inspirational persons, places or things; (29) personal data such as address, phone numbers, etc.; and (30) political views or party. If any of these items, or others, are claimed on a resume, job application or social networking profile, then efforts can be made to certify and document the information added or desired to be added to the profile.

The company or establishment hosting the profiles, has numerous publically available tools it can utilize in order to attempt to certify any of the claims, data or information that the user has indicated or wishes to include on the profile. The Host can also, with the requestor's permission, contact others to certify the accuracy of the data on the profile. The Host can also submit questions to the user for additional information or possibly to verify certain information.

The Host can also offer or provide additional services to the user which can enhance the user's knowledge and/or experiences. These services could make the user more successful, either in the business world or personally as a better person or citizen. The services could prevent the user from proceeding along the wrong path in life. The Host can interrogate the user with numerous questions, either orally or in writing which would allow these additional services to be welcomed and utilized.

The service tools which can help the user after enrollment in the Host's system include, for example: (1) aid in preparing resumes; (2) aid in interviewing; (3) feedback from employers; (4) occupational tutorials; (5) career testing; (6) personal branding; (7) job forums; (8) language assistance; (9) working with recruiters; (10) services for youths and senior citizens; (11) directory of any desired services; (12) assessment of available opportunities; (13) assessment of the requestor's skills; (14) matching of the requestor's skill and experience with available job descriptions; (15) networking tools in the requestor's field(s) of interest; (16) profiles of successful people in the requestor's field(s) of interest; (17) career path alternatives; (18) interactive calendars; (19) career and salary comparisons; (20) contact lists and address books; (21) vocational training; and (22) relocation services. There are, of course, numerous other services that the Host could supply to the users. Some of the services could be offered free and others at various charges or fees.

The certification process for the profile is the same as, or similar to, the certification process described above with respect to the resume certification program. The profile certification can include internet databases, phone inquiries, credit checks, government records and other investigative measures. For categories like membership in certain groups or organizations, or directorships or officer positions, internet sources and telephone inquiries may be sufficient. For publications and articles, again the internet could be the best source for certification. Asking the user for copies or documents verifying the information also could be sufficient. Language skills, hobbies, personal activities, philosophies, and the like, are categories which might not be certifiable absent a personal interview with the user - either orally or in writing. Checks with credible references could also be utilized. Promotions, additional education, or academic data, achievement awards the like can be certified in many ways, as discussed earlier with reference to FIG. 1-9. Securing permission for the user can be secured relative to any matters involving privacy issues.

In addition, the information on the social profiles could be designated or divided into groups or categories depending on the reliability of the information secured or utilized to attempt to verify and certify the information.

Corrections to profile data can also be made as discussed above. The user is first provided with an opportunity to correct any inaccuracies. If the information is still not correct, then the categories in question is either marked “uncertified”, or removed from the profile.

This embodiment of the invention creates a process of “imagineering” helping to define the user's or person's desired occupation, as well as defining what occupations the user does not want. Also, with this process, it helps persons who have a continued interest in keeping the education, achievements and certifications up to date throughout the person's working and social lives. Constantly reviewing and updating to add the latest improvements, could help the person's career advances, techniques and tactics. Keeping up to date with friends, professional contacts, and acquaintances could help the user both socially and professionally.

By taking users' academic and personal interests into account, suggested avenues and opportunities could be provided which were not previously considered by the users.

As with the situation concerning employment resumes discussed above, the social networking profile, if updated, could be used to secure new employment or advancements in the users' present employment.

Since the user structures and controls the personal information through the requests for certification, privacy issues may not be involved to any extent. Of course, any requests which are certified based on public data and information should not have privacy concerns.

The solid networking profile, like a resume, can be a social network and a map of specified ties, such as for business purposes or for friendship. The nodes to which the user is connected are the social contacts of that person.

Once the profile is started and completed at one point in time, the users should be interested in constantly updating the academic, educational, business advancements, and experience developments throughout life. By constantly updating the profile, the user has the most to gain, both monetarily and socially. The users thus have a vested interest in updating the career status and latest duties and responsibilities to increase professional opportunities and social standing.

The profile process and program combines varied intelligence in order to display the user's successful achievements and experiences. The profile also learns cumulatively over the user's life. The profile is a dynamic communication structure that is operationally and cost efficient and that reflects its objectives in a focused communication format. Learned facts are continually added to the growing database. The documents and facts are reviewed more accurately and efficiently over time for any user based on past reviews for that user. The program codifies in real time a dynamic learning and reporting system resume that assists the user in numerous ways.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. A method performed by a processor for creating and updating a social networking profile for a user of the social network, comprising:
initiating, via the user, a certification request of the social network profile to a host, the certification request consisting of a plurality of categories associated with the user's social networking profile;
certifying, via the host, the plurality of categories in response a first subset of the plurality of categories being established in the host; and
generating new categories of the plurality of categories in response to the a second subset of the plurality of categories not being established in the host,
wherein one of the initiating, certifying and the generating is performed by the processor.

2. The method of claim 1, wherein the plurality of categories consists of at least one of: (1) charitable activities, including years of service, titles and duties; (2) membership in certain clubs, groups, organizations, including years of membership, titles, or offices held, and duties; (3) membership in “good standing” in the certain clubs, groups and organization; (4) hobbies; (5) reading materials that the person has read, may have read or recommends to others; (6) languages known, including ability to read and speak in certain languages; (7) personal interests; (8) outside activities; (9) places visited; (10) personal philosophies and/or religion; (11) screen name or other identifier names; (12) email address; (13) reachability through other social networking website; (14) links to websites; (15) internet social groups; (16) passport; (17) updated photographs of the person or other individuals; (18) personal specialties and skills; (19) directorships or officers of groups or entities; (20) interest in other social or business clubs; (21) changes/advancements in business; (22) awards; (23) publications/articles authored or co-authored; (24) high school, including activities and sports teams; (25) active interests; (26) financial matters; (27) mentors, coaches or advisors; (28) inspirational persons, places or things; (29) personal data such as address, phone numbers, etc.; and (30) political views or party.

3. The method of claim 1, wherein the plurality of categories is defined by all of: (1) charitable activities, including years of service, titles and duties; (2) membership in certain clubs, groups, organizations, including years of membership, titles, or offices held, and duties; (3) membership in “good standing” in the certain clubs, groups and organization; (4) hobbies; (5) reading materials that the person has read, may have read or recommends to others; (6) languages known, including ability to read and speak in certain languages; (7) personal interests; (8) outside activities; (9) places visited; (10) personal philosophies and/or religion; (11) screen name or other identifier names; (12) email address; (13) reachability through other social networking website; (14) links to websites; (15) interne social groups; (16) passport; (17) updated photographs of the person or other individuals; (18) personal specialties and skills; (19) directorships or officers of groups or entities; (20) interest in other social or business clubs; (21) changes/advancements in business; (22) awards; (23) publications/articles authored or co-authored; (24) high school, including activities and sports teams; (25) active interests; (26) financial matters; (27) mentors, coaches or advisors; (28) inspirational persons, places or things; (29) personal data such as address, phone numbers, etc.; and (30) political views or party.

4. The method of claim 1, wherein the host is defined by an entity that provides profile certification for the user.

5. The method of claim 1, further comprising allowing the host to contact an interested party in the certification of the user's profile.

6. The method of claim 1, further comprising prompting the user to pay a fee in order to perform the certification.

7. The method claim 1, wherein the interested party determines of if the one of the plurality of categories being certified is accurate.

8. The method of claim 1, further comprising allowing the host to prompt the user with a request for additional information to certify at least one of the plurality of categories in the second subset.

9. The method of claim 1, wherein the social networking site removes information from the social networking profile based on the certification not being possible for at least one of the plurality of categories.

10. The method of claim 1, further comprising indicating to other users of the social network whether the user's social networking profile is certified.

11. The method of claim 1, further comprising allowing the user to request an update of the certification.

12. The method of claim 10, further comprising allowing the user to selectively share the certification with the other users.

13. The method of claim 6, wherein the fee is a periodic subscription.

14. The method of claim 1, wherein the host automatically updates the certification.

15. The method of claim 1, wherein the certification further comprises prompting the user for an interview process to in the certification.
